(19) United States
(12) Patent Application Publication
(10) Pub. No.: US 2019/0326795 A1
(43) Pub. Date: Oct. 24, 2019

(54) Torque Driven Dynamic Electrical Generator

(71) Applicant: Craig H. Zeyher, Haddonfield, NJ (US)

(72) Inventor: Craig H. Zeyher, Haddonfield, NJ (US)

(21) Appl. No.: 16/458,159

(22) Filed: Jun. 30, 2019

Related U.S. Application Data
(63) Continuation-in-part of application No. 15/984,080, filed on May 18, 2018.
(60) Provisional application No. 62/603,141, filed on May 19, 2017.
(60) Provisional application No. 62/603,770, filed on Jun. 12, 2017.
(60) Provisional application No. 62/604,733, filed on Jul. 19, 2017.
(60) Provisional application No. 62/604,893, filed on Jul. 26, 2017.
(60) Provisional application No. 62/605,559, filed on Aug. 18, 2017.
(60) Provisional application No. 62/605,708, filed on Aug. 24, 2017.
(60) Provisional application No. 62/606,819, filed on Oct. 10, 2017.
(60) Provisional application No. 62/606,992, filed on Oct. 16, 2017.
(60) Provisional application No. 62/707,664, filed on Nov. 13, 2017.
(60) Provisional application No. 62/709,853, filed on Feb. 5, 2018.
(60) Provisional application No. 62/766,162, filed on Oct. 5, 2018.
(60) Provisional application No. 62/766,541, filed on Oct. 25, 2018.
(60) Provisional application No. 62/766,911, filed on Nov. 13, 2018.
(60) Provisional application No. 62/917,557, filed on Dec. 17, 2018.

(51) Int. Cl. H02K 7/18; G01C 19/38; F03B 13/14

(52) U.S. Cl. CPC H02K 7/1892; F05B 2210/16; F03B 13/14; G01C 19/38

(57) ABSTRACT

A generator system having a dynamo that contains an armature, a stator and a housing. The armature rotates about a first axis of rotation. The stator is concentrically positioned around the armature. Both the armature and the stator are free to rotate in opposite directions about the first axis of rotation. The housing of the dynamo is connected to a motor that can rotate the dynamo around a second axis of rotation. There is an angle of inclination between the first axis of rotation and the second axis of rotation. This angle of inclination is selectively altered during operation by arms that attach to torque converters. By changing the angle of inclination between the two axes of rotation, a precession can be created that adds rotational energy to both the armature and the stator. This increases the output of the dynamo and creates a highly efficient electrical generator.

### RELATED APPLICATIONS

This application is a continuation-in-part of co-pending U.S. patent applications Ser. No. 15/984,080 filed May 18, 2018, which claims the priority of U.S. Provisional Application No. 62/709,853, filed Feb. 5, 2018.

This application also claims the priority of the following provisional patent applications:

U.S. Provisional Patent Application No. 62/766,162, filed Oct. 5, 2018;

U.S. Provisional Patent Application No. 62/766,541, filed Oct. 25, 2018;

U.S. Provisional Patent Application No. 62/766,911, filed Nov. 13, 2018; and

U.S. Provisional Patent Application No. 62/917,557, filed Dec. 17, 2018.

### BACKGROUND OF THE INVENTION

### 1. Field of the Invention

In general, the present invention relates to electrical generators, wherein conductive windings on an armature are moved through a magnetic field to produce electricity. More particularly, the present invention relates to electrical generators where both the electrical windings and the source of the magnetic field are in motion as electricity is generated.

### 2. Prior Art Description

It is well known that moving a coil of conductive wire through a magnetic field induces a flow of electricity in the conductive wire. Most electrical generators operate on this principle, wherein an armature of coiled wire is rotated within a stator that contains either permanent magnets or field magnets. It is very desirable to create a generator that converts mechanical rotational energy into electricity in an efficient manner. The efficiency of an electrical generator directly relates to the cost associated with running the generator. That is, efficient electrical generators take less power to run and can, therefore, be run at a lower cost.

Often, the efficiency of a generator is improved by altering the windings on the armature or the magnetic fields produced by the stator. However, another way to improve the efficiency of a generator is to add some mechanism that increases or prolongs the ability of the armature to spin. For example, in many manually operated handheld generators, a hand crank is typically used to turn a flywheel. The flywheel, in turn, rotates the armature. The flywheel prolongs the period of time that the armature turns so the user does not have to constantly move the crank.

In the prior art, the armatures of electrical generators have been attached to most every device that can produce rotational energy, including gyroscopes. Such prior art is exemplified by U.S. U.S. Pat. No. 5,313,850 to Finvold and International Patent Publication No. WO/2014/104938 to Zaytsev. However, in such prior art, the armature of a generator is attached to a gyroscopic system, and receives rotational energy from the gyroscope. The generator itself is not part of the gyroscopic system.

A configuration has been discovered for an electrical generator, wherein the components of the generator are dynamically set into motion as part of a larger gyroscopic system. This increases the rotational speed of the components, therein resulting in a more efficient generation of electrical power. This improved generator system is described and claimed below.

### SUMMARY OF THE INVENTION

The present invention is a generator system that converts mechanical energy into electricity. The generator system has a dynamo that contains an armature, a stator and a housing and torque converting assembly. The armature rotates about a first axis of rotation. The stator is concentrically positioned around the armature. Both the armature and the stator are capable of rotating about the first axis of rotation within the housing. During operation, the armature and the stator rotate in opposite directions around the first axis of rotation.

The housing that holds the armature and the stator is connected to a motor that can rotate the dynamo around a second axis of rotation. As such, the armature and the stator rotate around both the first axis of rotation and the second axis of rotation. There is an angle of inclination between the first axis of rotation and the second axis of rotation. This angle of inclination can be selectively altered during operation.

The housing rotates within a containment shell. Extensions extend from the housing within the containment shell, wherein armature and stator axles contact and run along the interior of the containment shell through use of a friction element, Wheel or track. A gimbal mount is provided to the housing within the containment shell. The gimbal mount enables the housing and the extensions to be selectively inclined within said containment shell. The angle of inclination is controlled by a tilt mechanism.

As the armature and the stator spin, gyroscopic forces are created as are complex magnetic fields. By changing the angle of inclination between the two axes of rotation, a precession can be created that adds rotational energy to both the armature and the stator. This increases the output of the system and creating a highly efficient electrical generator.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic of a traditional prior art dynamo that contains an armature set in a fixed stator;

FIG. 2 is a schematic showing the dynamic rotational movements of a dynamo as part of the present invention generator system;

FIG. 3 is a schematic showing the moving components within a dynamo as utilized by the present invention generator system;

FIG. 4 shows a fragmented cross-sectional view of an exemplary embodiment of the generator system in a first configuration;

FIG. 5 shows a fragmented cross-sectional view of the exemplary embodiment of the generator system in a second configuration;

FIG. 6 shows a top view of the exemplary generator system with the containment shell in cross-section; and

FIG. 7 is a fragmented view showing an alternate embodiment of a containment shell that utilizes a friction track and ball-bearing arrangement.

### DETAILED DESCRIPTION OF THE DRAWINGS

The present invention generator can be configured in many ways and can be adapted for use in many applications. For example, the electrical generator can be used by a utility company to generate electricity for a power grid. Much small versions can be used to generate electricity for home use or to provide electrical power to a boat or vehicle. Although the generator can be used in many such applications, only one exemplary system is illustrated and described. The exemplary embodiment is selected in order to set forth one of the best modes contemplated for the invention. The illustrated embodiment, however, is merely exemplary and should not be considered a limitation when interpreting the scope of the appended claims.

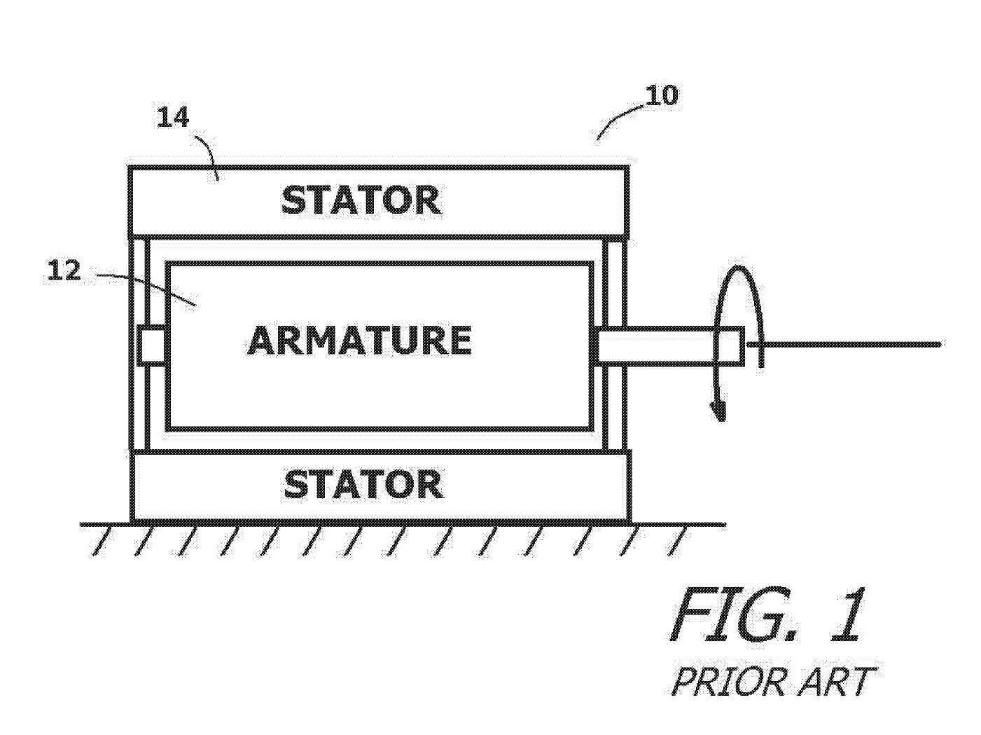

Referring to FIG. 1, a traditional prior art generator 10 is illustrated as a comparative reference. The generator 10 has an armature 12 that rotates within a stator 14. The armature 12 rotates, while the stator 14 remains stationary. The armature 12 contains various windings of copper or some other conductive metal wire. The stator 14 contains permanent magnets or field magnets that are powered by the armature 12 via the process of self-excitation. The stator 14 generates a magnetic field. The armature 12 rotates through the magnetic field, whereby electricity is generated in windings of the armature 12.

In such a traditional electrical generator 10, the armature 12 is the only part of the generator 10 that rotates. It has been discovered that the efficiency of an electrical generator can be significantly increased if other aspects of the electric generator are also placed into motion.

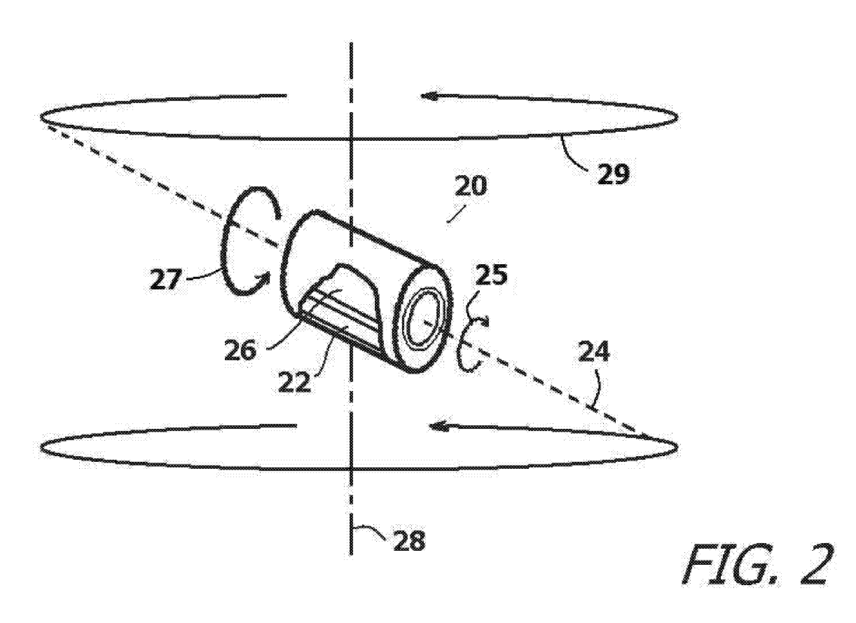

Referring to FIG. 2, a generator system 20 is shown where an armature 22 rotates in a first direction about a first axis of rotation 24, as is indicated by arrow 25. Additionally, a stator 26 is concentrically positioned around the armature 22. The stator 26 is caused to rotate about the same axis of rotation 24 in the opposite direction, as is indicated by arrow 27. Accordingly, the armature 22 and the stator 26 are simultaneously rotating in opposite directions. This creates a higher relative speed of rotation and a corresponding higher output in electrical power. Additionally, the subassembly of the armature 22 and the stator 26 is inclined while spinning. The subassembly is then spun around a second axis of rotation 28, as is indicated by arrow 29. This produces a gyroscopic procession that increases the rotational speed of the armature 24 and stator 26. Consequently, more electrical power is produced. The result is a generator system 20 that produces more power and is more efficient than generators with equally sized armatures but with stationary stators.

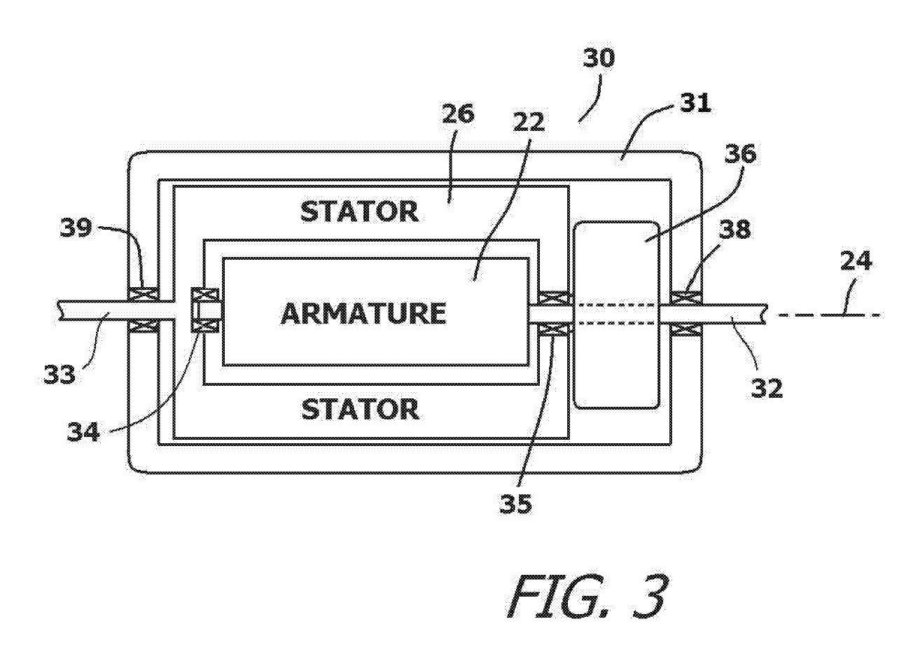

Referring to FIG. 3, it can be seen that the armature 22 and the stator 26 of the generator system 20 are held within a housing 31. The armature 22, stator 26 and housing 31 form a dynamo subassembly 30. The armature 22 rotates about an armature axle 32. The armature axle 32 extends along the first axis of rotation 24. The armature axle 32 is suspended within the housing 31 by bearings 34. The bearings 34 enable the armature 22 to rotate within the confines of the housing 31. A drive motor 36 is provided that can be used to rotate the armature axle 32 and the armature 22. The drive motor 36 can selectively disengage the armature axle 32 should the armature 22 be induced to rotate above the operational speed of the drive motor 36.

The armature 22 is surrounded by the stator 26. The stator 26 contains either permanent magnets or field magnets. The stator 26 is supported by bearings 35 on the armature axle 32 and bearings 39 on the stator axle 33 in the housing 31. As such, the stator 26 is able to rotate about the armature 22. Arranged in this manner, both the armature 22 and the stator 26 can rotate around the first axis of rotation 24, which is concentric with the armature axle 32 and stator axle 33. The armature 22 and stator 26 are thus configured to rotate within the housing 31. The housing 31 surrounds the armature 22 and the stator 26, completing the dynamo subassembly 30.

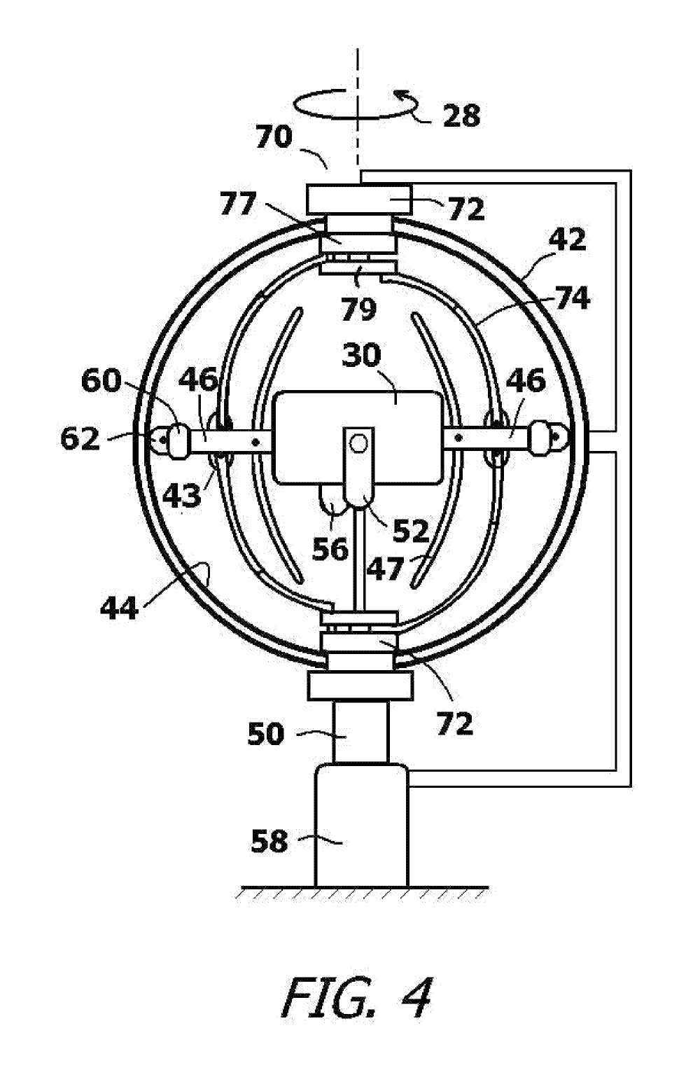

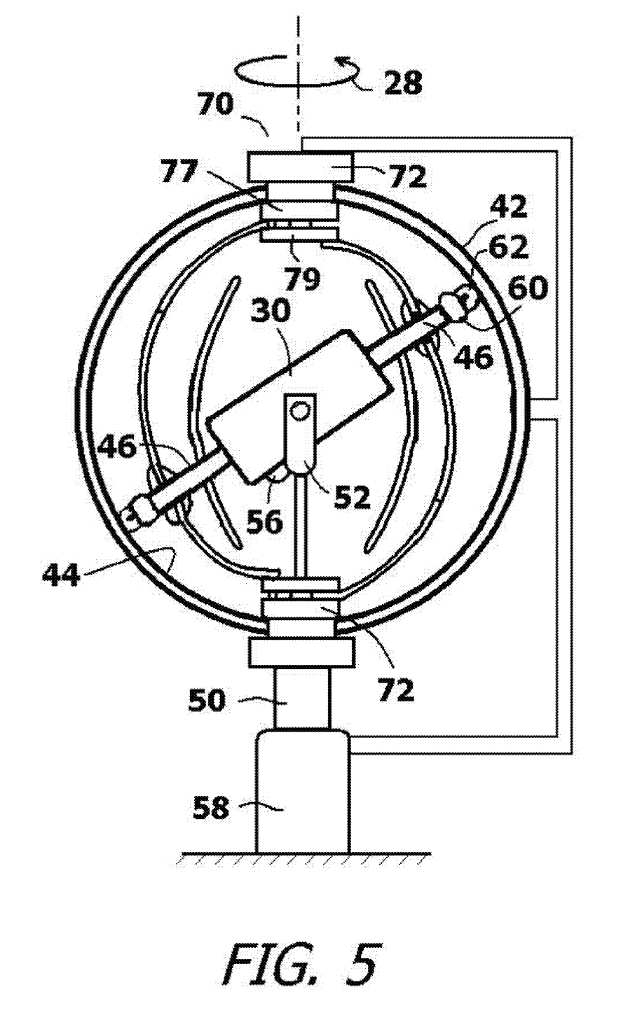

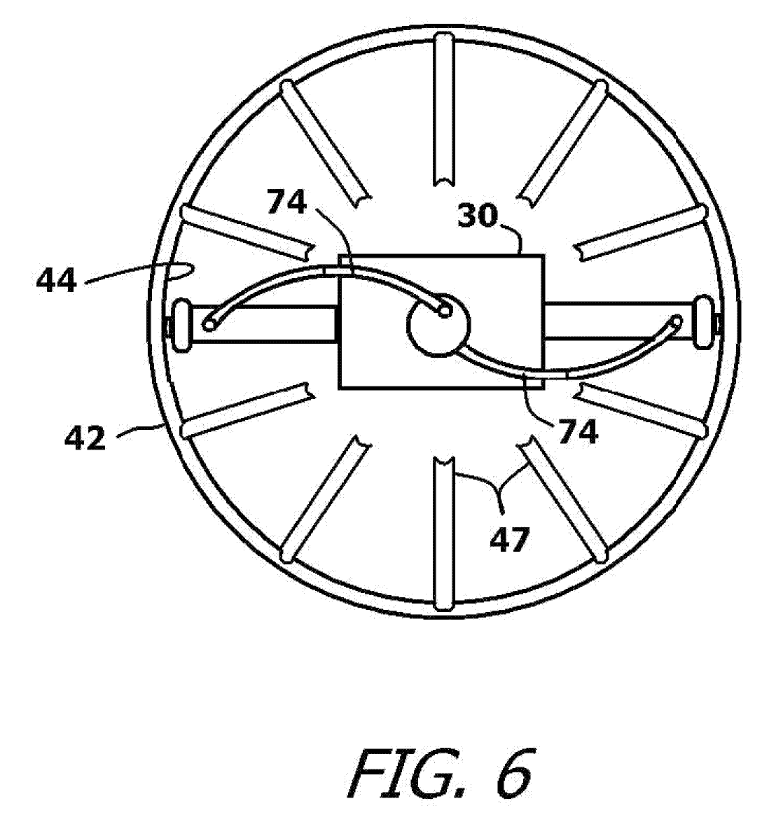

Referring to FIG. 4, FIG. 5 and FIG. 6 in conjunction with FIG. 3, it can be seen that a containment shell 42 surrounds the dynamo subassembly 30. The containment shell 42 has a spherically curved interior surface 44. Extensions 46 extend from the dynamo subassembly 30 that house the stator axle 33 and the armature axle 32. The extensions 46 terminate with gear boxes 60 that rotate a friction drive wheel 62. The friction drive wheels 62 run along the curved surface 44 of the containment shell 42, being powered by the stator axle 33 and armature axle 32. A full description of the gear box 60 and friction drive wheel 62 are provided in the co-pending parent application Ser. No. 15,984,080, the disclosure of which is herein incorporated by reference. Rotation of either the stator 26 or the armature 22 insures coordinated rotation of the other by virtue of their mutual axle contact with the inner curved surface 44 of the containment shell 42, or with an alternative friction track 45 yet to be described) Conversely, as will be shortly described, the frictional drive wheels or modified axles are used to drive stator and armature rotation.

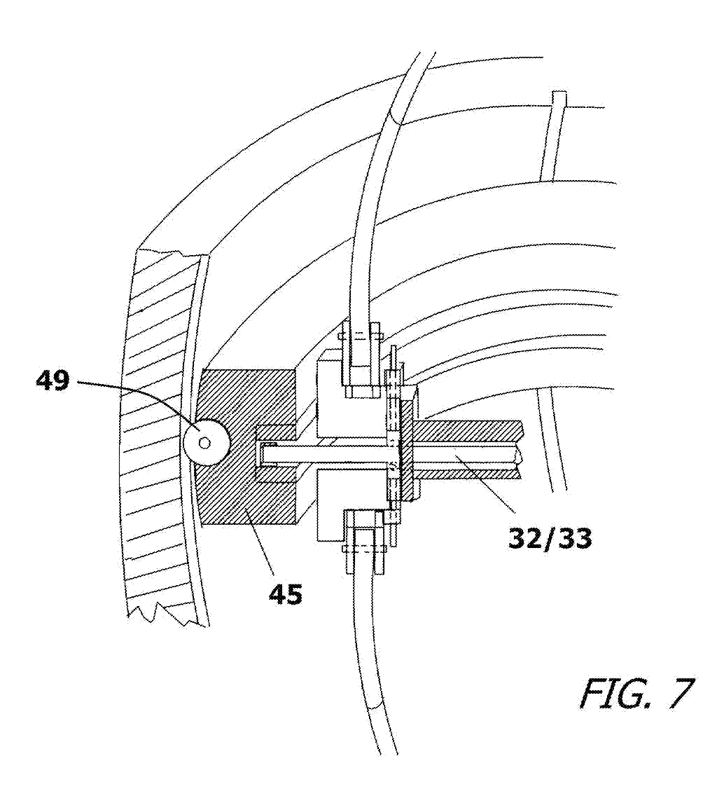

Alternatively, as is shown in FIG. 7, the curved surface of the containment shell 42 can be modified to accommodate a friction track 45. The friction track 45 then accommodates the ends of the rolling surface of the axles 32 and 33 modified to insure frictional contact when running within the friction track to drive rotational motion of the armature 22 and stator 26 in response to applied forces. Some friction tracks are described in co-pending patent application Ser. No. 15/984,080, the disclosure of which has been incorporated by reference. The dynamo subassembly 30 can be tilted to a desired angle of inclination during operations. The dynamo subassembly 30 will remain at this angle with both ends of the extensions 46 traveling in a circular path around the vertical axis with one extension higher than the other, as is shown in FIG. 2. Undulations could be limited by the travel of the ball bearings in friction tracks, which are circular. In the embodiment of FIG. 4, FIG. 5 and FIG. 6, the extensions 46 that support the gear boxes 60 and the friction drive wheels 62 rotate around the vertical axis with the dynamo subassembly 30.

Referring to FIG. 7, it can be seen that alternative embodiments can also be used. For example, the axles 32 and 33 can terminate and ride within a friction track 45. The friction track 45 rides on ball bearings 49 guided by tracks 47 on the inner surface of the containment shell 42 and undulates in accordance with forces exerted upon. A support column 50 is provided. A gimbal 52 is set atop the support column 50. The housing 31 of the dynamo subassembly 30 is set upon the gimbal 52. The gimbal 52 can be engaged or disengaged to enable the dynamo subassembly 30 to rotate in a second axis of rotation 28 which is in the vertical plane. This rotation is initiated by engaging a column motor drive 58, that rotates the support column 50, and/or engaging the motor drive 36 in the housing 31. Upon adequate rotation, the stator axle 33, the armature axle 32, and the dynamo subassembly 30 can be tilted out of the horizontal plane (FIG. 4) and into an inclined plane (FIG. 5).The stator axle 33 and armature axle 32 remain in contact with the containment shell 42, via the drive wheels 62, regardless of the angle of inclination. The tilting of the dynamo subassembly 30 is controlled by a tilt mechanism 56 and/or by telescoping arms 74, as are later described.

When using tilt mechanism 56 is activated, the dynamo subassembly 30 is tilted. The tilt mechanism 56 can be controlled using a computer controlled gear drive, a lever, a hydraulic arm, or any other device capable of rotating the dynamo subassembly 30 to a selected inclined angle within the gimbals 52.

A torque converting apparatus 70 is used to offset the dynamo subassembly 30 once it is rotating at an operational speed. As the dynamo subassembly 30 is offset, a torque is produced that is utilized to help drive precession. The torque converting apparatus 70 includes two torque converters 72 that are placed above and below the dynamo subassembly 30. Telescoping arms 74 extend from the torque converters 72. The telescoping arms 74 extends from the torque converters 72 and mount to the extensions 46 that house the stator axle 33 and armature axle 32. The telescoping arms 74 are curved, but are also adjustable in length. That is, the length of the telescoping arms 74 can extend or contract as directed by a systems controller. The telescoping arms 74 can expand or contract through hydraulic or electrical means. The telescoping arms 74 are used to selectively offset the axis of the dynamo subassembly 30 once the system is in operation. The telescoping arms 74 can eliminate the need for the separate tilt mechanism 56. However, the telescoping arms 74 can be also be used in combination with the tilt mechanism 56 to allow for a certain degree of “play” when the system is in operation.

The torque converters 72, are located above and below the dynamo subassembly 30, in line with the center of rotation. Each torque converter 72 has two spring loaded disks 77, 79 that are capable of shifting position. An optional transmission and pivotal or adjustable sliding connection can be provided between both the disks 77, 79 and the telescoping arms 74. Upon motor drive application and revolution of the dynamo subassembly 30 around the second axis of rotation 28 as previously described, the telescoping arms 74 are activated so that the dynamo subassembly 30 is offset from its original axis of rotation. This can be accomplished solely by use of the telescoping arms 74 or with the assistance of the previously mentioned tilt mechanism 56. When utilized in combination with the offsetting tilt mechanism 56, sensors are used to disengage this device through a computer control at some predetermined or desired angle of inclination. This allows the torque created by the offset rotating dynamo assembly 30 to react solely with the telescoping arms 74 and related torque converters 72. Due to the angle of inclination, one of the two telescoping arms 74 will be longer than the other. The longer of the two telescoping torque arms 74 being pushed upward (or downward) by the natural propensity of a spinning object seeking to restore itself to its original axis of rotation. The forces applied to the telescoping arms 74 are mechanically transferred to the spring loaded disks 77, 79 of the torque converters 72. The primary disk 77 causes compression upon an internal spring assembly and shifts the position of the disk 77 on its axle such that the second spring loaded disk 79 is engaged. This causes an increased force to be exerted upon the shorter telescoping arm and ultimately to the dynamo subassembly 30 through the telescoping arms connection to the extensions 46. This assists armature rotation by helping to drive precession of the offset rotating dynamo subassembly 30. Leverage can be employed in this design not only in use of the longer and shorter telescoping arms 74 but also in the positioning of the interconnection between spring loaded disks 77, 79, use of an intermediary transmission and spring arrangement, size, etc. Also, a mechanical advantage may be gained as the torque produced by the dynamo subassembly 30 undergoes precession when subject to forced precession can result in a significant increase in torque with minimal expenditure of precession driving force. The result is a more efficient drive arrangement whereby external supplied motor driving force can be reduced.

The support column 50 extends below the center of gravity of the dynamo subassembly 30. The wiring for directing power to and from the dynamo subassembly 30 extends through the support column 50. As mentioned, the support column 50 is rotated by a motor 58 outside of the rotational zone and can be disengaged upon command. Initially, the external motor 58 rotates the gimbal 52 and the dynamo subassembly 30 around the second axis of rotation 28 but ultimately redirected torque forces help sustain or increase rotation.

With reference to all prior figures, the operation of the generator assembly 20 is herein described. At the start of operations, using the drive motor 36 and/or 58 the armature 22 is rotated about the armature axle 32 at the operational speed of the drive motor 36 or by use of motor drive 58. The armature 22 will begin to generate electricity in the traditional manner. Within the dynamo subassembly 30, the armature 22 and the stator 26 are concentrically spinning in opposite directions. This increases relative speed. The contact of the stator axle 33 and armature axle 32 to the containment shell 44, via the friction drive wheel 62 or through use of an alternative friction track 45 ensure that the armature 22 and the stator 26 rotate in response to applied forces traveling in the same direction on a common circular path.

The entire dynamo subassembly 30 is then rotated by rotating the gimbals 52 atop the support column 50 by use of motor drive 58. Once rotating, the plane of rotation for the dynamo subassembly 30 can be inclined therein inclining the first axis of rotation 24. As such, both the armature 22 and the stator 26 are rotating together about the vertical second axis of rotation 28, while they are rotating opposite each other along the now inclined first axis of rotation 24.

Torque resulting from the inclined rotating assembly is then utilized to help drive precession. The armature 22 and the stator 26 have a common gyroscopic procession as they rotate about the second axis of rotation 28. However, the armature 22 and the stator 26 are rotating in opposite directions in the first axis of rotation 24. The result is the generation of a complex interplay of magnetic fields. As the procession about the second axis of rotation 24 is increased, the gyroscopic forces experienced within the dynamo subassembly 30 also increase. This produces an increase in the rotational speed of the armature 22 and the stator 26 within the dynamo subassembly 30. The increase of rotational speed induced in the armature 22 and the stator 26 results in greater electrical output and a corresponding increase in magnetic strength between components. This in turn creates still greater driving force and electrical and magnetic output. This cycle can be continued within operational limits until either electrical or mechanical power is taken from the spinning generator system 10 to do useful work.

It will be understood that the embodiment of the present invention that is illustrated and described is merely exemplary and that a person skilled in the art can make many variations to that embodiment. All such embodiments are intended to be included within the scope of the present invention as defined by the appended claims.

What is claimed is:

1. A generator system comprising:
an armature that rotates about a first axis of rotation;
a stator concentrically positioned about said armature, wherein said stator is able to rotate about said first axis of rotation;
a housing for supporting said armature and said stator, wherein both said armature and said stator rotate about said first axis of rotation within said housing;
a containment shell that surrounds said housing;
extensions that extend from said housing and contact said containment shell;
a gimbal mount for said housing within said containment shell that enables said housing to be selectively inclined within said containment shell.

2. The generator system according to claim 1, further including a motor for rotating said housing about a second axis of rotation that is different from said first axis of rotation, wherein said extensions contact said containment shell as said housing rotates about said second axis of rotation.

3. The generator system according to claim 2, further including a first arm that engages one of said extensions in said containment shell and rotates about said second axis of rotation with said housing and said extensions.

4. The generator system according to claim 3, further including a first torque converter mounted to said containment shell, wherein said first arm extends from one of said extensions to said first torque converter.

5. The generator system according to claim 4, wherein said first arm has a length that is adjustable to accommodate inclination of said extensions within said containment shell.

6. The generator system according to 3, further including a second arm that engages one of said extensions in said containment shell and rotates about said second axis of rotation with said housing and said extensions.

7. The generator system according to claim 6, further including a second torque converter mounted to said containment shell, wherein said second arm extends from one of said extensions to said second torque converter.

8. The generator system according to claim 7, wherein said second arm has a length that is adjustable to accommodate inclination of said extensions within said containment shell.

9. The generator system according to claim 3, further including a mechanism for selectively moving said housing in said gimbal mount, therein controlling an angle of inclination for said first axis of rotation.

10. The generator system according to claim 3, further including a motor for rotating said gimbal mount in said containment shell, therein rotating said housing and said at least one extension within said containment shell.

11. The generator system according to claim 1, wherein said armature rotates about said first axis of rotation in a first direction and said stator rotates about said first axis of rotation in an opposite second direction.

12. The generator system according to claim 1, further including a drive motor within said housing for rotating said armature about said first axis of rotation.

13. The generator system according to claim 1, further including tracks in said containment shell, wherein said extensions engage said tracks and said tracks guide movement of said extension in said containment shell.

14. A generator system comprising:
an armature that rotates about a first axis of rotation;
a stator concentrically positioned about said armature, wherein said stator is able to rotate about said first axis of rotation;
a housing for supporting said armature and said stator, wherein both said armature and said stator rotate about said first axis of rotation within said housing;
extensions that extend from said housing, wherein said extension terminate with wheels that are driven by said armature and said stator;
a containment shell that surrounds said housing, wherein said wheels on said extensions engage and roll along said containment shell; and
a gimbal mount for said housing within said containment shell that enables said housing and said extensions to be selectively inclined within said containment shell.

15. The generator system according to claim 14, further including a tilt mechanism for selectively moving said housing in said gimbal mount, therein providing said extension with an angle of inclination.

16. The generator system according to claim 15, further including a motor for rotating said housing about a second axis of rotation that is different from said first axis of rotation.

17. The generator system according to claim 15, further including arms that engage said extensions in said containment shell and rotates about said second axis of rotation with said housing and said extensions.

18. The generator system according to claim 17, further torque converters mounted to said containment shell, wherein said arms extends from said extensions to said torque converters.

19. The generator system according to claim 18, wherein said arms are adjustable in length to accommodate said angle of inclination of said extensions within said containment shell.

20. The generator system according to claim 15, further including a mechanism for selectively moving said housing in said gimbal mount, therein controlling an angle of inclination for said first axis of rotation.
